(19) United States
(12) Patent Application Publication
(10) Pub. No.: US 2013/0027162 A1
(43) Pub. Date: Jan. 31, 2013

(54) Miniature Neutral Toroidal Current Transformer

(71) Applicants: Harry James Carlino, Export, PA (US); Lloyd Allen Maloney, Beaver, PA (US); Martha Suryani Bucchi, Wexford, PA (US)

(72) Inventors: Harry James Carlino, Export, PA (US); Lloyd Allen Maloney, Beaver, PA (US); Martha Suryani Bucchi, Wexford, PA (US)

(21) Appl. No.: 13/194,371

(22) Filed: Jul. 29, 2011

(51) Int. Cl. H01F 27/02; H01F 27/24; H01F 41/04; H01F 17/06

(52) U.S. Cl. 336/90; 336/221; 336/213; 29/606

(57) ABSTRACT

A toroidal current transformer that can be used as a neutral current transformer in a single or three phase system as a result of its compactness is described. The core is made of ferromagnetic material having a primary winding and a secondary winding.

### FIELD

The present disclosure relates to current transformers. Moreover, it relates to miniature neutral toroidal current transformers.

### BACKGROUND

Current transformers (CT) are can be used for measuring of electric currents and can be implemented in a variety of systems. One example of such systems can include power distribution systems, meters and protective relays. When current in a circuit is too high to directly apply to measuring instruments or measuring sensors, a current transformer produces a reduced current that is proportional to the current in the circuit, which can be conveniently connected to measuring and recording instruments. A current transformer can also isolate the measuring instruments or sensors from what can be considered a high voltage in the monitored circuit.

Similarly to other transformers, a current transformer has a primary winding, a core, and a secondary winding. The current flowing in the primary winding produces a magnetic field in the core, which then induces a current in the secondary winding circuit. A primary objective of current transformer design is to ensure that the primary and secondary circuits are efficiently coupled, so that the secondary current bears an accurate relationship to the primary current.

The most common design of CT consists of a length of wire wrapped many times around a silicon steel ring passed over the circuit being measured. Shapes and sizes can vary depending on the end user or switchgear manufacturer. Examples of low voltage single ratio metering current transformers can be ring type or plastic molded case. High-voltage current transformers can be mounted on porcelain bushings to insulate them from ground. Some CT configurations can be configured to slip around the bushing of a high-voltage transformer or circuit breaker.

The CT core is constructed of ferromagnetic materials, which tend to “saturate” at a predetermined level that can be dictated by, for example, the core material and the core dimensions. The saturation point is where any further increase in magnetizing field force (H) does not result in a proportional increase in magnetic flux density (B) or any more increase in the secondary current resulting from this magnetic flux change. Consequently, the CT secondary waveform can become highly distorted and of relatively low magnitude.

### SUMMARY

According to a first aspect, a current transformer is described, the current transformer comprising: a substantially toroidal core having a height, and a width; a secondary winding wrapped about the height and the width of the core, the secondary winding being a wire having a diameter and extending around an entire circumference of the core; wherein a diameter of the center of the core is equal to or greater than a diameter of a largest conductive wire and insulation surrounding a conductive wire adapted to pass through a center of the core, wherein the core saturates when a primary current flowing through the conductive wire exceeds a set primary current, and wherein the current transformer is adapted to convert the primary current to a secondary current induced by the secondary winding, the second current being a function of a number of turns of the secondary winding and the primary current, and wherein the current transformer is configured to be a neutral current transformer associated with a ground fault circuit breaker.

According to a second aspect, a method of making a compact current transformer is described, the method comprising: providing a taped substantially toroidal core having a height, and a width, the toroidal core being made of a material having a permeability; providing a secondary winding wrapped about the height and the width of the core, the secondary winding being a wire having a diameter and extending around an entire circumference of the substantially toroidal core; and optimizing a set saturation point of the toroidal core by optimizing the permeability of the material of the core, the diameter of the wire of the secondary winding, and a cross-sectional area of the toroidal core, the cross sectional area being a product of the height and the width of the substantially toroidal core.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 shows an exemplary molded case circuit breaker.

FIG. 2 shows a block diagram of an exemplary circuit interrupter.

FIGS. 3-4 show perspective sectional views of an exemplary neutral current transformer according to some embodiments of the present disclosure.

FIGS. 5A-5B show a frontal view and a cross-sectional view of a toroidal core of neutral current transformer according to some embodiments of the present disclosure.

FIG. 6 shows a graph showing a cross-section of a taped core of the neutral current transformer according to some embodiments of the present disclosure.

### DETAILED DESCRIPTION

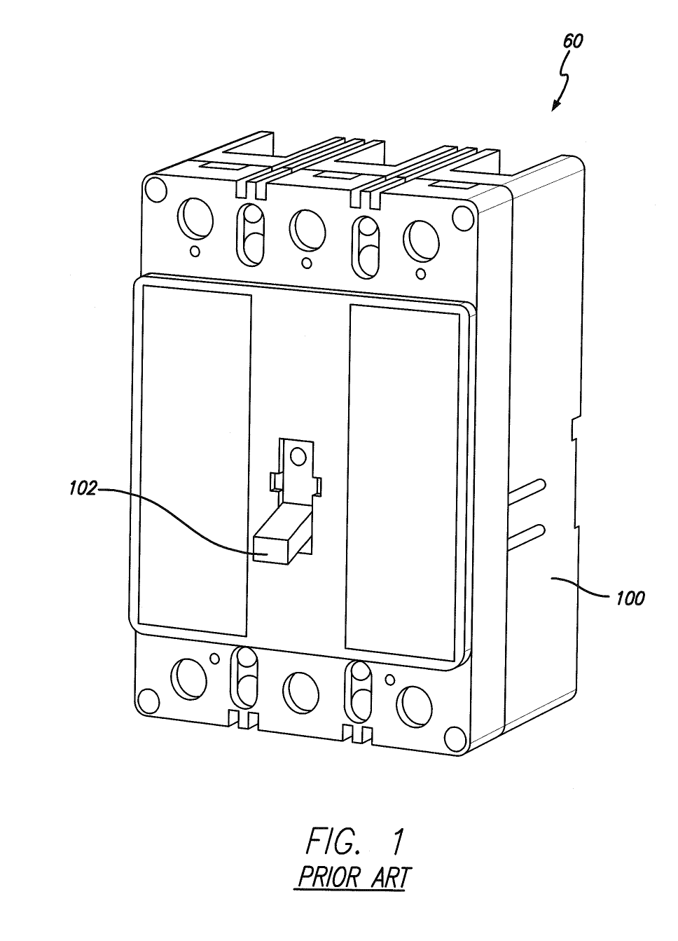

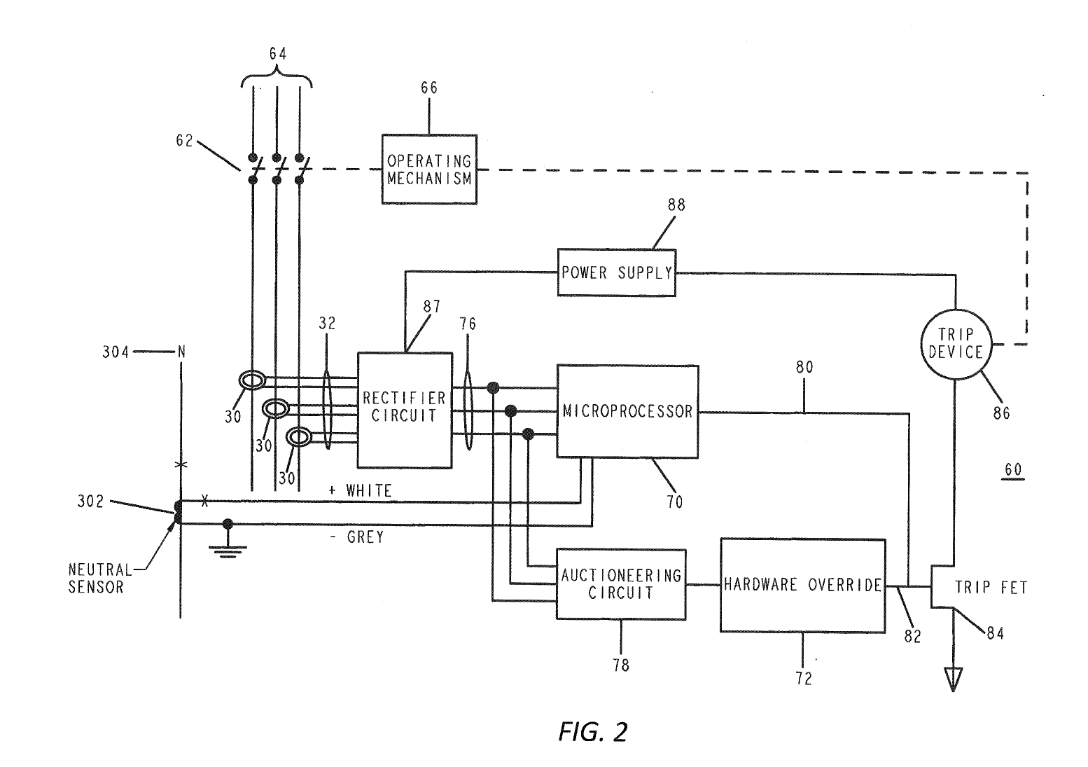

FIGS. 1-2 show a circuit interrupter, such as a molded case circuit breaker (MCCB) (60) (e.g., frame size domestic electronic (FDE) circuit breaker), including a housing (100) in which a number of separable contacts (62) (e.g., without limitation, a pair for each phase) are contained. As shown in FIG. 2, the separable contacts (62) can be associated with conductors (64) of a power distribution system including, for example, three phases. The separable contacts (62) can be operated automatically in response to an overcurrent condition. The separable contacts (62) can also be operated manually by way of an operating handle (102) (see FIG. 1) disposed on the outside of the circuit breaker (60). Conventionally, the circuit breaker (60) includes an operating mechanism (66), which can be structured to open and close the separable contacts (62), and a trip unit, such as a trip assembly (68), which can sense overcurrent conditions. Upon sensing an overcurrent condition, the trip assembly (68) can actuate the operating mechanism (66) to a trip position, which can move the separable contacts (62) to their open position, as shown.

In an example embodiment as shown in FIG. 2, the trip assembly (68) can employ both a microprocessor (70) and a hardware override circuit (72) to detect an overcurrent condition and/or to actuate the operating mechanism (66). The trip assembly (68) can cooperate with a number of current sensors, such as internal current transformers (30), in order to provide to a rectifier circuit (74) current proportional to the current flowing in the corresponding conductors (64) and through the corresponding separable contacts (62). The three outputs (76) of the rectifier circuit (74) can be provided to both the microprocessor (70) and an auctioneering circuit (78), which can output a peak sensed current value to the hardware override circuit (72). In response to an overcurrent condition, the microprocessor (70) and/or the hardware override circuit (72) can produce various trip signals (80) (82) (e.g., without limitation, short delay trip; long delay trip; instantaneous trip; breakpoint trip), which can be provided to a trip field effect transistor (FET) (84) that drives a trip device, such as a trip coil (86). The trip coil (86), in turn, can actuate the operating mechanism (66), in order to trip open the separable contacts (62). As also shown in FIG. 2, another output (87) of the rectifier circuit (74) can supply power from the secondary windings (32) of the internal current transformers (30) to a power supply (88), in order to power the trip coil (86) and the rest of the trip assembly (68).

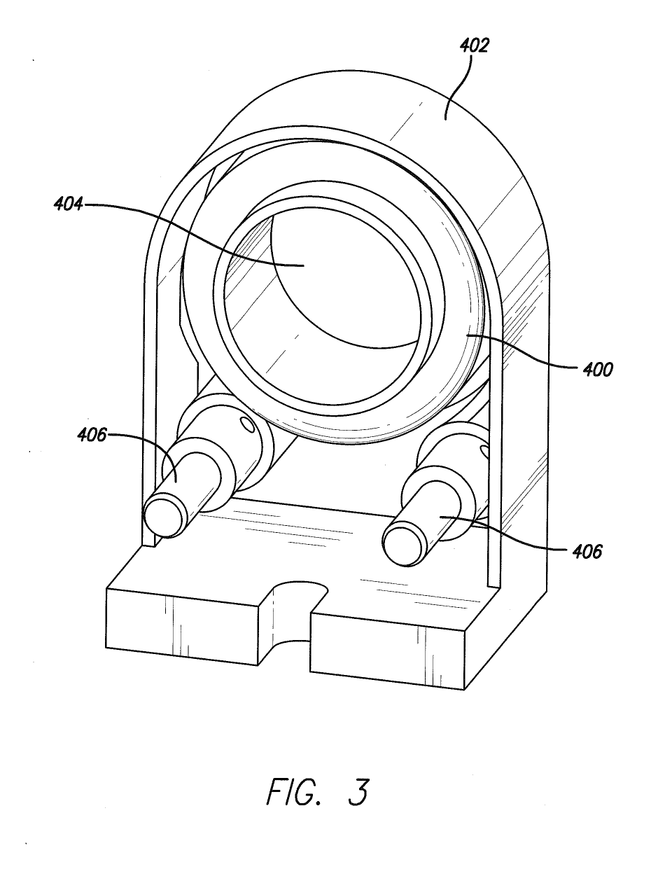

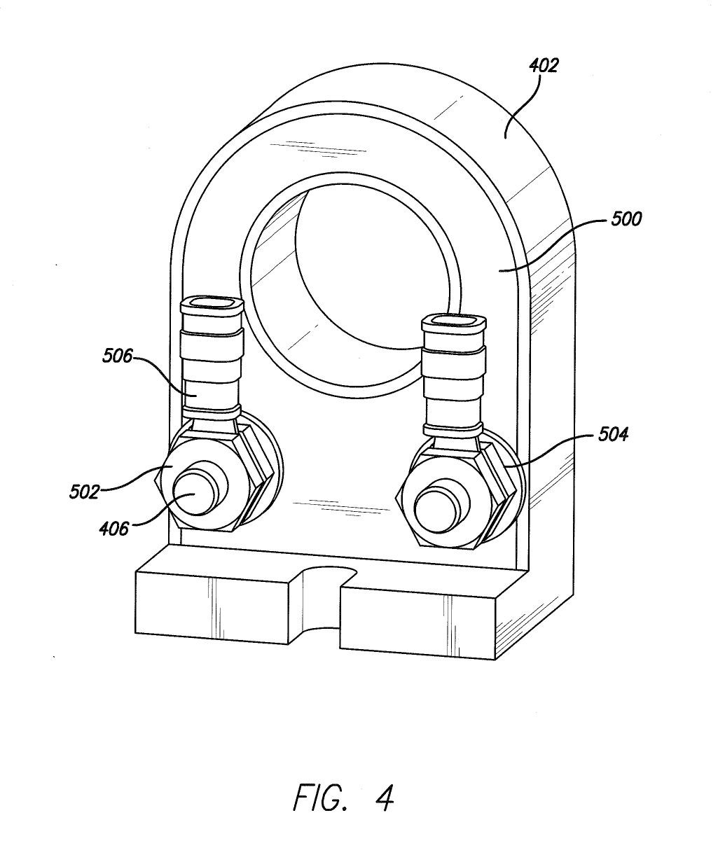

In addition to the internal current transformers (30), the circuit interrupter can be associated with an additional current transformer (see FIGS. 3-4) configured to be utilized outside the circuit interrupter assembly. Such external current transformer can be a neutral current transformer used as a ground fault circuit breaker in single or three phase systems. By way of example and not of limitation, a three phase ground fault circuit breaker can be a residual type circuit breaker that detects a ground fault by first, summing the three line currents for each of the three phases. Since each line current is expected to have the same magnitude and each phase is has a phase relationship of 0, 120, and 240 degrees apart, the vector sum can be expected to be zero. Thus, if the sum is not zero, then the magnitudes of the line currents are not equal, and the difference can be inferred to be a ground fault in the circuit. The neutral current transformer (302) can be connected to the microprocessor (70) and configured to monitor the neutral current in the neutral wire (304). If the neutral current transformer is part of a single phase system, then the neutral current is the same current as the in-phase current. If the neutral current transformer is part of a three phase system, then the neutral current is a difference of a vector addition of the three phase currents. FIGS. 3-4 show a toroidally shaped neutral current transformer according to embodiments of the present disclosure, which can be arranged compactly in a casing to allow, in use, passage of a current carrying conductor through the center of the toroidally shaped current transformer.

Now referring particularly to the neutral current transformer shown in FIGS. 3, 4, 5A-5B, the core (400) of the neutral current transformer can be made of taped core (600) (e.g., taped silicon steel, silicon-iron alloy, cobalt-iron alloy, nickel-iron alloy, or other alloys). The taped core (600) can be wound in a plurality of layers to form the core (400) having dimensions that determine suitable magnetic characteristics and the physical dimensions to fit in the current transformer casing (402) shown in FIGS. 3-4.

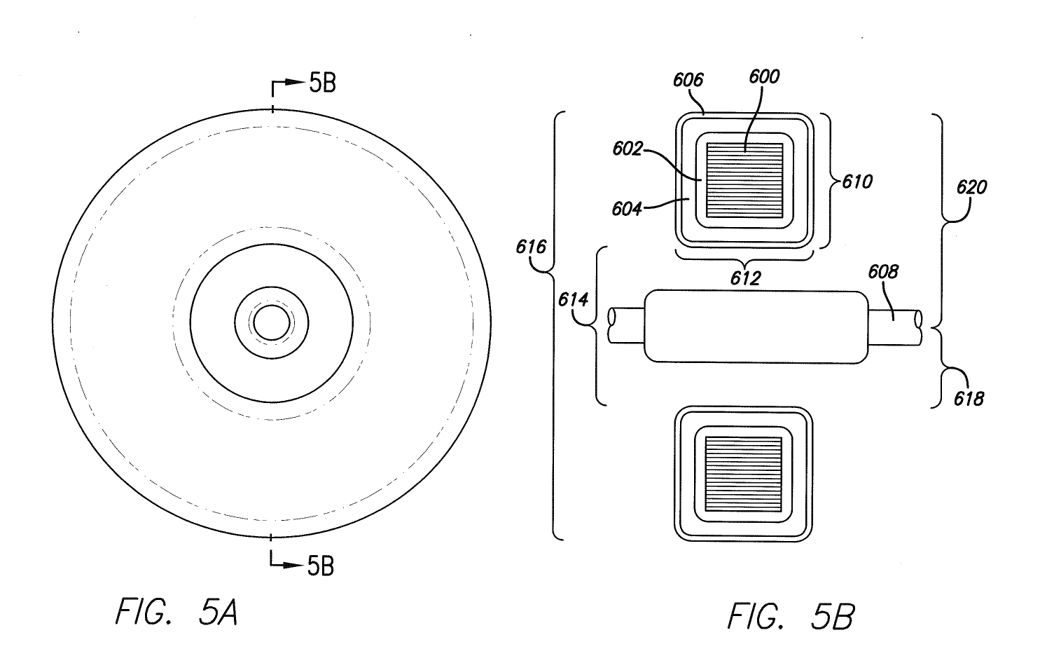

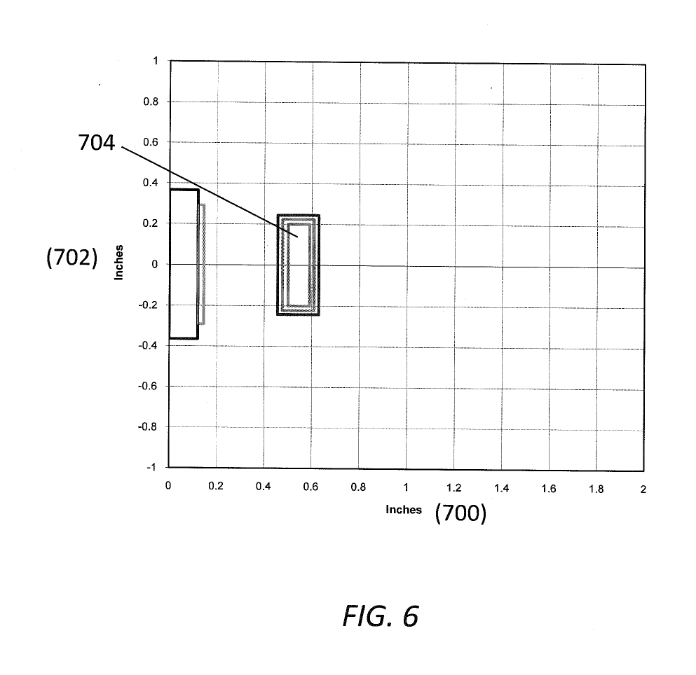

FIGS. 5A-5B show a front view and a cross-sectional view showing an exemplary neutral current transformer in accordance with the present disclosure made by winding a plurality of layers of an elongated length of the taped core (600) having a reluctance and a width; forming a generally circular cylindrical neutral current transformer core (400) having a central opening (404), thereby forming a substantially toroidal shape, a height (612), a width (610), an inner diameter (614) and an outer diameter (616) from the winding of the elongated length of taped core (600); the height (612) of the neutral current transformer core (400) corresponding to the width (610) of the elongated length of taped core (600); and the width (610) of the neutral current transformer core (400) being equal to a difference between an outer radius (620) and an inner radius (618). A first insulating material (602) (e.g., core casing) can be layered over the entire taped core (600) and a secondary winding (604) is then disposed about the first insulating material (602) in a conventional manner. The second windings (604) can be wound around the taped core (600) around the entire toroid. A second insulating material (606) can then be layered over the secondary windings, thereby enclosing the entire current transformer core (400). A cross sectional view of the core (704) is shown in FIG. 6 where the X-axis (700) represents the width and the Y-axis (702) represents the height of the core.

The toroidal shaped core (400) allows for the passage of a conductive wire through a center (608) of the core (400), and the core (400) can be mounted in the casing (402) as described in previous paragraphs. FIG. 4 shows the neutral current transformer of FIG. 3 with potting (500) to fill the cavity in the casing (402) and the potting (500) covers the entire core (400). Two studs (406) are further connected to the casing (402) which can be electrically connected to the circuit interrupter using wires, connector lugs (506), nuts (502) and washers (504).

In one embodiment of the present disclosure, the core of the neutral current transformer can be configured by initially determining the largest expected diameter of the conductive wire, including any insulation on the conductive wire that will pass through the toroidal neutral current transformer. Such diameter can become the minimum inner diameter of the core, thereby ensuring that the largest expected conductor is able to fit through the toroidal core. Additionally, the desired physical finished dimensions (e.g., height, width) of the current transformer are also determined. Then the desired ratio of the primary current to the secondary current, as well as the magnitudes of the primary current and the secondary current are also determined. Once the desired inner diameter, current ratios and magnitudes are established, a plurality of mathematical formulas and equations can be used to calculate other parameters to optimize the core.

One such optimization parameter is the saturation point of the core. The saturation point is reached when a further increase in the field intensity (H) ceases to cause an increase in flux density (B), where the relationship between the field intensity (H) and flux density (B) can be expressed by:

B=μH, (1)

where (μ) is the permeability of the core material. A higher permeability of the ferromagnetic material can result in greater flux density. The flux density (B) can also be expressed as:

B=Niμ/2(π)r, (2)

where (N) is the turns ratio of the current transformer and (i) is the magnetizing current. The average radius (r), of the core can be express as:

r=(r2+r1)/2, (3)

where (r2) is the inner radius, and (r1) is the outer radius of the core. Therefore, the field intensity (H) can be represented as:

H=Ni/2(π)r, (4)

and a cross-sectional area of the core (A) can be expressed as:

A=h(r1−r2)/2, (5)

where h is the height of the core. Finally, the total flux density Φ can be expressed as:

Φ=BA. (6)

By way of the above described equations, the core can be configured to produce a desired flux density without reaching or exceeding a predetermined saturation point. Factors such as the core material (μ), cross-sectional area of the core (A), and the size of the wire used as the secondary winding can have a significant effect on the saturation of the core. For example, it can be seen from the equations above that a smaller wire size can result in a higher resistance and thus decrease the saturation point, or decreasing the cross-sectional area of the core to decrease the saturation point. The term “turns ratio” in a transformer is typically defined as the ratio of the number of turns of the secondary winding to the primary winding. However, in the exemplary current transformer, the number of turns of the primary windings is one. Therefore, the turns ratio as used in herein in the present disclosure is intended to mean the number of turns of the secondary winding.

In some embodiments, the mathematical equations can computed automatically by a computer configured perform such calculations. According to an exemplary method, a macro can be programmed in a spreadsheet such that a user can input desired parameters such as the core material (μ), cross-sectional area of the core (A), and the size of the wire used as the secondary winding to obtain a first order design. By inputting such parameters, a user can determine if such combination of parameters meet the desired specification (e.g., does not exceed the desired saturation parameters). Additionally, the macro can be configured to also calculate parameters such as wound wire resistance, stacking factor (e.g., amount of space a wire needs for winding), expected saturation curves, power dissipated, and estimated finished physical dimensions.

In the exemplary configuration as described in the present disclosure, the core of the neutral current transformer is smaller than the current transformers internal to the circuit breaker. Accordingly, saturation will occur at a lower current for the smaller core. By way of example and not of limitation, the neutral current transformer of the present disclosure is configured such that the core will not saturate until more than approximately 200% of the expected current is sensed. However, other saturation points are also possible.

When the conductive wire that passes through the core (400) of the neutral current transformer carries current, the wire induces a magnetic field, which is sensed by the secondary windings on the taped core of the neutral current transformer. The neutral current transformer is configured to down convert the current passing through the wire to a lower current which can be fed to the circuit interrupter, according to a predetermined ratio (e.g., 225 A:60 mA, 160 A:60 mA, 80 A:60 mA). The ratio refers to the ratio of a primary current to a secondary current, and the ratio of the neutral current transformer is configured to match the ratio of the current transformers internal to the circuit interrupters.

In the exemplary embodiment of the present disclosure, the secondary winding on the taped core is configured to produce 60 mA of secondary current from a primary current of 225 A. By way of example and not of limitation, a 225 A to 60 mA ratio neutral current transformer can have 3750 turns of wire (e.g., winding) to configure such ratio. In another embodiment, the secondary winding on the taped core can comprise 2667 turns of wire to provide the same 60 mA of secondary current for a primary current of 160 A. In yet another embodiment, the secondary winding on the taped core can comprise 1333 turns of wire to again produce the same 60 mA of secondary current for a primary current of 80 A in an 80 A to 60 mA ratio current transformer. Other ratios and combinations of the number of turns of wire are also possible.

As shown in FIGS. 5A-5B, it is noted that both the inner diameter (614) and the outer diameter (616) are a factor of the number of layers of the taped core (600) and the secondary windings (604). Greater number of turns of the secondary windings (600) can enlarge the thickness of the toroidal core, thereby increasing both the outer diameter (616) and the inner diameter (614). Likewise, increasing the number of layers of the tape core (600) can increase either or both the outer diameter (616) and/or the inner diameter (614). Additionally, the thickness of the layer of the taped core (600) material and the thickness of the wire of the secondary winding (604) can also vary the inner diameter (614) and the outer diameter (616).

It should be noted that the particular arrangement of components shown in the figures are non-limiting examples and that other arrangements, within the scope of the invention, are possible. For example, although discussed as separate components, it is contemplated that the hardware override circuit (72) and the microprocessor (70) can be implemented as a single device, such as and without limitation, an integrated circuit (not shown). Alternatively, a wide range of analog and/or digital circuits (not shown) may be employed. Furthermore, any suitable number of power lines or phases may be employed.

The examples set forth above are provided to give those of ordinary skill in the art a complete disclosure and description of how to make and use the embodiments of the miniature neutral current transformer of the disclosure, and are not intended to limit the scope of what the inventors regard as their disclosure. Modifications of the above-described modes for carrying out the disclosure may be used by persons of skill in the art, and are intended to be within the scope of the following claims. All patents and publications mentioned in the specification may be indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

A number of embodiments of the disclosure have been described. Nevertheless, it will be understood that various modifications may be made without departing from the spirit and scope of the present disclosure. Accordingly, other embodiments are within the scope of the following claims.

1. A current transformer comprising:
a substantially toroidal core having a height, and a width; and
a secondary winding wrapped about the height and the width of the core, the secondary winding being a wire having a diameter and extending around an entire circumference of the core,
wherein a diameter of the center of the core is equal to or greater than a diameter of a largest conductive wire and insulation surrounding a conductive wire adapted to pass through a center of the core,
wherein the core saturates when a primary current flowing through the conductive wire exceeds a set primary current,
wherein the current transformer is adapted to convert the primary current to a secondary current induced by the secondary winding, the second current being a function of a number of turns of the secondary winding and the primary current, and
wherein the current transformer is configured to be a neutral current transformer associated with a ground fault circuit breaker.

2. The current transformer according to claim 1, wherein the number of turns of the secondary winding is a turns ratio.

3. The current transformer according to claim 1, wherein the substantially toroidal core is a taped core.

4. The current transformer according to claim 1, wherein the core is optimized as a function of one or more of: permeability of a material of the core, a cross sectional area of the core, and a size of the wire of the secondary winding.

5. The current transformer according to claim 1, further comprising:
an insulating material covering the core; and
a casing containing the core, the secondary winding, and the insulating material.

6. The current transformer according to claim 1, wherein the taped core is made by rolling a tape shaped material in a rolled configuration, having a hollow center such that the tape core is in a toroidal configuration, the tape shaped material selected from the group consisting of: steel, silicon, silicon-iron alloy, cobalt-iron alloy, and nickel-iron alloy.

7. The current transformer according to claim 1, wherein the width of the core varies between an outer radius of the core and an inner radius of the core.

8. The current transformer according to claim 1, wherein the height of the core is a function of the width of the tape shaped material.

9. The current transformer according to claim 1, wherein the primary current is selected from the group consisting of: 225 amps, 160 amps, and 80 amps.

10. The current transformer according to claim 1, wherein the secondary current is 60 milliamps.

11. The current transformer according to claim 1, wherein 3750 turns of the secondary winding pertains to a 225 amps to 60 milliamps ratio current transformer.

12. The current transformer according to claim 1, wherein 2667 turns of the secondary winding pertains to an 160 amps to 60 milliamps ratio current transformer.

13. The current transformer according to claim 1, wherein 1333 turns of the secondary winding pertains to an 80 amps to 60 milliamps ratio current transformer.

14. The current transformer according to claim 7, wherein an inner diameter of the core is a function of a thickness of the taped core, thickness of the secondary winding, number of turns of the secondary winding, and a number of layers of the taped core.

15. A method of making a compact current transformer, comprising:
providing a taped substantially toroidal core having a height, and a width, the toroidal core being made of a material having a permeability;
providing a secondary winding wrapped about the height and the width of the core, the secondary winding being a wire having a diameter and extending around an entire circumference of the substantially toroidal core; and
optimizing a set saturation point of the toroidal core by optimizing the permeability of the material of the core, the diameter of the wire of the secondary winding, and a cross-sectional area of the toroidal core, the cross sectional area being a product of the height and the width of the substantially toroidal core.

16. The method according to claim 15, wherein the optimizing prevents the toroidal core from saturating until the set saturation point is reached.

17. The method according to claim 16, wherein the set saturation point is selected to be 200% of a rated maximum primary current.
